(19) United States
(12) Patent Application Publication
(10) Pub. No.: US 2008/0129631 A1
(43) Pub. Date: Jun. 5, 2008

(54) Broadband circularly polarization antenna device

(76) Inventors: Chih-Ming Chen, Hsinchu (TW); Min-Sheng Ma, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/633,444

(22) Filed: Dec. 5, 2006

(51) Int. Cl. H01Q 1/38; H01Q 1/52

(52) U.S. Cl. 343/841; 343/700 MS

(57) ABSTRACT

A broadband circularly polarization antenna device includes: a dielectric body, a patch, an antenna feed pin, and a grounding layer. The patch is disposed on a top surface of the dielectric body. The antenna feed pin is extended outward from a bottom surface of the dielectric body. One part of the grounding layer is coated on the bottom surface of the dielectric body, and the other part of the grounding layer is coated entirely around a lateral side of the dielectric body. Because the grounding layer is coated on the bottom surface and the lateral side of the dielectric body, the bandwidth of the antenna device is increased and interference from a PCB and other surrounding circuits to the antenna device is greatly reduced, thereby ensuring the antenna device performs well.

### BACKGROUND OF THE INVENTION

1. Field of the Invention

The present invention relates to a broadband circularly polarization antenna device, and particularly relates to a broadband circularly polarization antenna device that has a grounding layer coated on a bottom surface and a lateral side of a dielectric body thereof.

2. Description of the Related Art

Due to the development of communication technology, a lot of electronic products have been developed that use wireless communication technology, such as cell phones, wireless Internet devices, and personal digital assistants (PDAs), etc. The requirements demanded for the wireless communication devices from consumers has become higher and higher, namely in terms of the appearance and dimensions of the devices. For cell phones, the receiving frequency has developed from a single frequency, to two, then three, and now four frequencies. Consumers also prefer cell phones having the characteristics of a fresh appearance, small dimensions, a light weight, and portability.

Moreover, the receiving-signal effect of wireless communication devices is an important index for evaluating the wireless communication devices. The antenna apparatus is a key factor to determine the receiving-signal effect of wireless communication devices. Therefore, it is important to develop an antenna apparatus that has an excellent receiving-signal effect and meets the demands of fresh appearance and small dimension.

Referring to FIGS. 1 and 2, a known circular polarization antenna device 1a includes a dielectric body 11a, a patch layer 12a, an antenna feed pin 13a, and a grounding layer 14a.

The patch layer 12a is formed on a top surface of the dielectric body 11a. The antenna feed pin 13a is extended outward from a bottom surface of the dielectric body 1a. The grounding layer 14a is only coated on the bottom surface of the dielectric body 11a. The patch layer 12a (positive pole) is mated with the grounding layer 14a (negative pole) for generating a predetermined antenna magnetic field.

Referring to FIGS. 3 and 4, in order to increase the bandwidth of the known antenna device 1a during transmission of electromagnetic signals, the thickness of the dielectric body 11a needs to be increased. For example, in FIG. 3, the dielectric body 11a has a thickness h1 larger than a thickness h2 of a dielectric body 11b of a known circular polarization antenna device 1b. Hence, a transmission width d2 of electromagnetic signals s2 is obviously larger than a transmission width d1 of electromagnetic signals s1. In other words, the transmission width of electromagnetic signals is decided according to the thickness of the dielectric body.

Referring to FIG. 5, the antenna feed pin 13a is electrically connected with a PCB 2a that is disposed under the known antenna device 1a. Moreover, because the patch layer 12a (positive pole) is mated with the grounding layer 14a (negative pole) for generating the predetermined antenna magnetic field (electromagnetic signals s3 are transmitted from top to bottom), the electrical performance of the known antenna device 1a will be affected and changed by the size of the PCB 2a and other surrounding circuits.

### SUMMARY OF THE INVENTION

One particular aspect of the present invention is to provide a broadband circularly polarization antenna device. The antenna device has a dielectric body, and a grounding layer coated on a bottom surface and a lateral side of the dielectric body, so that the bandwidth of the antenna device is increased and interference from a PCB and other surrounding circuits to the antenna device is greatly reduced, thereby ensuring the antenna device performs well.

In order to achieve the above-mentioned aspects, the present invention provides a broadband circularly polarization antenna device, including: a dielectric body, a patch layer, an antenna feed pin, and a grounding layer. The patch layer is formed on a top surface of the dielectric body. The antenna feed pin is extended outward from a bottom surface of the dielectric body. One part of the grounding layer is coated on the bottom surface of the dielectric body, and the other part of the grounding layer is coated around a lateral side of the dielectric body.

In order to achieve the above-mentioned aspects, the present invention provides a broadband circularly polarization antenna device, including: a dielectric body, a patch layer, an antenna feed pin, and a metal shielding element. The patch layer is formed on a top surface of the dielectric body. The antenna feed pin is extended outward from a bottom surface of the dielectric body. One part of the metal shielding element is disposed on the bottom surface of the dielectric body, and the other part of the metal shielding element is disposed around a lateral side of the dielectric body.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective, schematic view of a circular polarization antenna device of the prior art;

FIG. 2 is a lateral, cross-sectional view of a circular polarization antenna device of the prior art;

FIG. 3 is a schematic view of signal transmission tracks of a circular polarization antenna device of the prior art;

FIG. 4 is a schematic view of signal transmission tracks of a broadband circularly polarization antenna device of the prior art;

FIG. 5 is a schematic view of signal transmission tracks of a circular polarization antenna device disposed on a PCB according to the prior art;

FIG. 6 is a perspective, schematic view of a broadband circularly polarization antenna device according to the first embodiment of the present invention;

FIG. 7 is a schematic view of signal transmission tracks of a broadband circularly polarization antenna device disposed on a PCB according to the first embodiment of the present invention;

FIG. 8 is a perspective, exploded view of a broadband circularly polarization antenna device according to the second embodiment of the present invention; and

FIG. 9 is a perspective, assembled view of a broadband circularly polarization antenna device according to the second embodiment of the present invention.

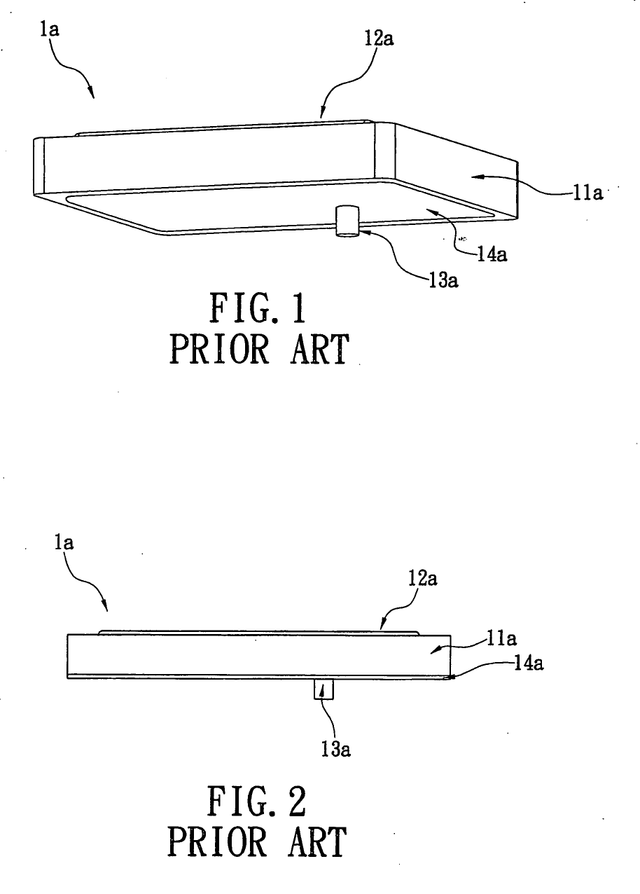

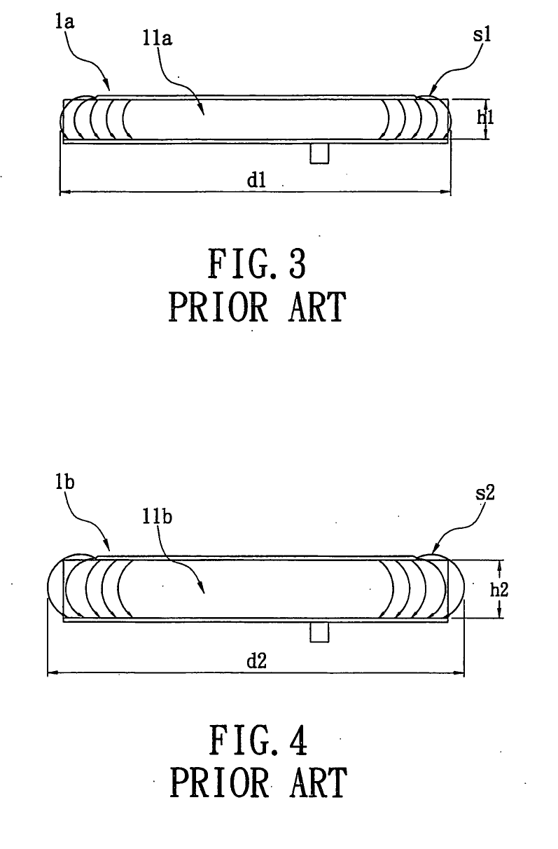

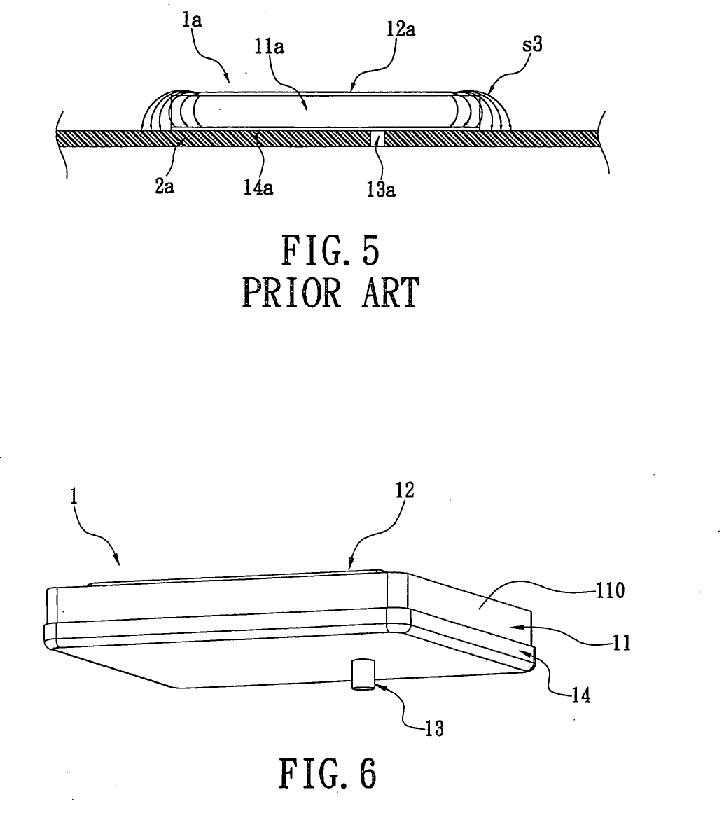

### DETAILED DESCRIPTION OF THE PREFERRED EMBODIMENTS

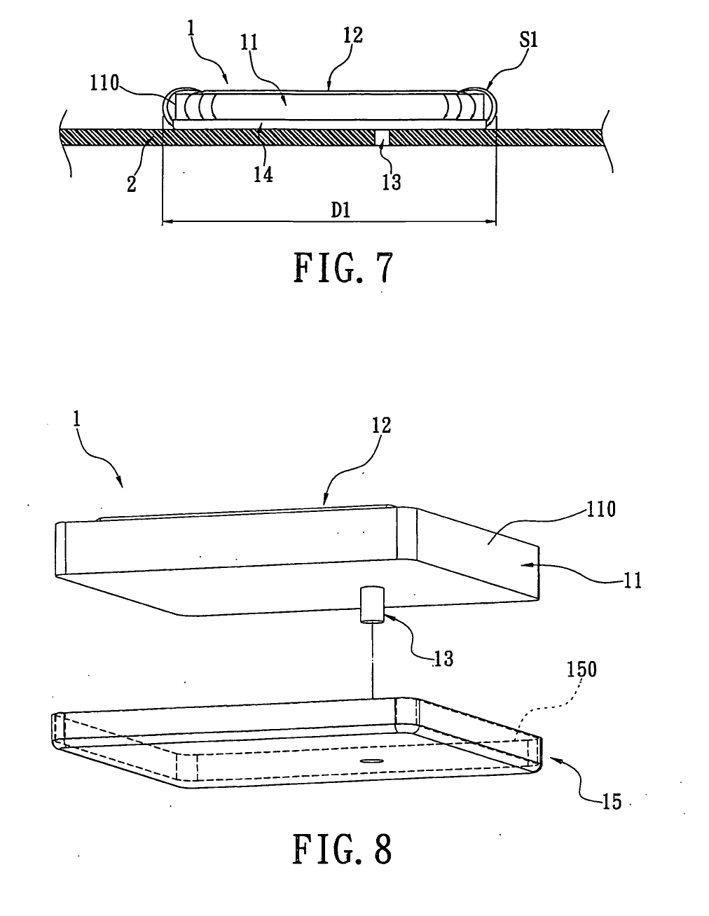

Referring to FIGS. 6 and 7, the present invention provides a broadband circularly polarization antenna device 1, comprising: a dielectric body 11, a patch layer 12, an antenna feed pin 13, and a grounding layer 14.

The dielectric body 11 can be made of dielectric material such as ceramic material. The patch layer 12 can be made of metal material such as copper or gold material, and the patch layer 12 is formed on a top surface of the dielectric body 11. Moreover, the antenna feed pin 13 is extended outward from a bottom surface of the dielectric body 11, and the antenna feed pin 13 is electrically connected with a PCB 2 that is disposed under the broadband circularly polarization antenna device 1.

Furthermore, the grounding layer 14 can be a conductive layer such as a conductive silver paste. One part of the grounding layer 14 is coated on the bottom surface of the dielectric body 11, and the other part of the grounding layer 14 is coated around a lateral side 110 of the dielectric body 11. In other words, the other part of the grounding layer 14 is extended upward from a circumference of the bottom surface of the dielectric body 11 for coating around the lateral side 10 of the dielectric body 11.

Hence, the grounding layer 14 is coated on the bottom surface and the lateral side 110 of the dielectric body 11 in order to generate a buffer effect that can increase a transmission width D of electromagnetic signals S1 of the broadband circularly polarization antenna device 1. Because the grounding layer 14 is coated on the lateral side 110 of the dielectric body 11, the interference from the PCB 2 and other surrounding circuits to the antenna device 1 is greatly reduced, thereby ensuring the antenna device 1 performs well.

However, the above-mentioned height of the grounding layer 14 on the lateral side 110 should not be used to limit the present invention. Any such coatings that make the grounding layer 14 formed on the lateral side 110 of the dielectric body 11 are protected in the present invention.

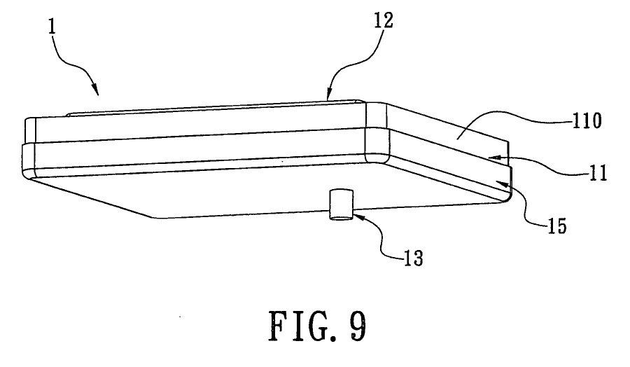

Referring to FIGS. 8 and 9, the difference between the second embodiment and the first embodiment is that in the second embodiment a metal shielding element takes a place of the grounding layer 14 of the first embodiment.

One part of the metal shielding element is disposed on the bottom surface of the dielectric body 11, and the other part of the metal shielding element is disposed around the lateral side 110 of the dielectric body 11. In other words, the other part of the metal shielding element is extended upward from the circumference of the bottom surface of the dielectric body in order to make the other part of metal shielding element dispose around the lateral side 110 of the dielectric body 11.

Furthermore, the metal shielding element is a metal cover 15 with a receiving space 150. A lower part of the dielectric body 11 is received in the receiving space 150 of the metal cover 15 for making the metal cover 15 cover the lower part of the dielectric body 11.

In conclusion, because the grounding layer 14 is coated or the metal shielding element (the metal cover 15) is disposed on the bottom surface and the lateral side 110 of the dielectric body 11, the bandwidth of the antenna device 1 is increased and interference from the PCB 2 and other surrounding circuits to the antenna device 1 is greatly reduced, thereby ensuring the antenna device 1 performs well.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A broadband circularly polarization antenna device, comprising:
a dielectric body a patch layer formed on a top surface of the dielectric body;
an antenna feed pin extended outward from a bottom surface of the dielectric body; and
a grounding layer, wherein one part of the grounding layer is coated on the bottom surface of the dielectric body, and the other part of the grounding layer is coated around a lateral side of the dielectric body.

2. The broadband circularly polarization antenna device as claimed in claim 1, wherein the dielectric body is made of ceramic material.

3. The broadband circularly polarization antenna device as claimed in claim 1, wherein the patch layer is made of copper or gold material.

4. The broadband circularly polarization antenna device as claimed in claim 1, wherein the antenna feed pin is electrically connected with a PCB that is disposed under the broadband circularly polarization antenna device.

5. The broadband circularly polarization antenna device as claimed in claim 1, wherein the grounding layer is a conductive layer.

6. The broadband circularly polarization antenna device as claimed in claim 5, wherein the conductive layer is a conductive silver paste.

7. The broadband circularly polarization antenna device as claimed in claim 1, wherein the other part of the grounding layer is extended upward from a circumference of the bottom surface of the dielectric body for coating around the lateral side of the dielectric body.

8. A broadband circularly polarization antenna device, comprising:
a dielectric body
a patch layer formed on a top surface of the dielectric body;
an antenna feed pin extended outward from a bottom surface of the dielectric body; and
a metal shielding element, wherein one part of the metal shielding element is disposed on the bottom surface of the dielectric body, and the other part of the metal shielding element is disposed around a lateral side of the dielectric body.

9. The broadband circularly polarization antenna device as claimed in claim 8, wherein the dielectric body is made of ceramic material.

10. The broadband circularly polarization antenna device as claimed in claim 8, wherein the patch layer is made of copper or gold material.

11. The broadband circularly polarization antenna device as claimed in claim 8, wherein the antenna feed pin is electrically connected with a PCB that is disposed under the broadband circularly polarization antenna device.

12. The broadband circularly polarization antenna device as claimed in claim 8, wherein the metal shielding element is a metal cover with a receiving space, and a lower part of the dielectric body is received in the receiving space of the metal cover for the metal cover covering the lower part of the dielectric body.

13. The broadband circularly polarization antenna device as claimed in claim 8, wherein the other part of the metal shielding element is extended upward from a circumference of the bottom surface of the dielectric body in order to make the other part of metal shielding element dispose around the lateral side of the dielectric body.
